(19) United States
(12) Patent Application Publication
(10) Pub. No.: US 2022/0359895 A1
(43) Pub. Date: Nov. 10, 2022

(54) SYSTEMS AND METHODS FOR REGULATING VOLTAGE FOR HYDROGEN-ELECTRIC ENGINES

(71) Applicant: ZeroAvia, Inc., Hollister, CA (US)

(72) Inventors: Stephen LAWES, Bedfordshire (GB); Ritish TEJPAL, Coventry (GB)

(73) Assignee: ZeroAvia, Inc., Hollister, CA (US)

(21) Appl. No.: 17/662,357

(22) Filed: May 6, 2022

Related U.S. Application Data
(60) Provisional application No. 63/185,666, filed on May 7, 2021.

(51) Int. Cl. H01M 8/04858; H01M 8/04537; H01M 8/04111; H01M 8/04082; H01M 8/1007; H01M 8/2457

(52) U.S. Cl. CPC H01M 8/04873; H01M 8/04552; H01M 8/04111; H01M 8/04201; H01M 8/1007; H01M 8/2457

(57) ABSTRACT

A hydrogen-electric engine includes a fuel cell stack including a plurality of fuel cells. Each fuel cell of the plurality of fuel cells includes an anode and a cathode. The hydrogen-electric engine also includes an air compressor system configured to supply compressed air to the cathode, a hydrogen fuel source configured to supply hydrogen gas, an elongated shaft supporting the air compressor system and the fuel cell stack, and a motor assembly disposed in electrical communication with the fuel cell stack. Each fuel cell generates a voltage, as an open cell voltage, by forming water with the supplied compressed air and the supplied hydrogen gas and is electrically coupled with a clamp circuit.

### CROSS-REFERENCE TO RELATED APPLICATIONS (PROVISIONAL)

This application claims priority to and benefit of co-pending U.S. Provisional Patent Application No. 63/185,666 filed on May 7, 2021, entitled “SYSTEMS AND METHODS FOR REGULATING VOLTAGE FOR HYDROGEN-ELECTRIC ENGINES” by Stephen Lawes et al., and assigned to the assignee of the present application, the disclosure of which is hereby incorporated by reference in its entirety.

### TECHNICAL FIELD

This disclosure relates to systems and methods for regulating voltage for hydrogen- electric engines, and more particularly, to systems and methods for clamping voltage of one or more fuel cells of a fuel cell stack of these hydrogen-electric engines.

### BACKGROUND

According to numbers from the Federal Aviation Administration (FAA), the number of pilot licenses issued every year is increasing. The largest collection of licenses is in the private category. Contributing to this pattern, the lowest barrier of entry into private aviation is through the use of a small single engine aircraft, which generally includes an internal combustion aviation engine. In fact, the internal combustion engine contains a large number of moving parts with a low level of integration and which operate under large mechanical and thermal stresses. This unnecessarily adds weight and volume to the aircraft, negatively affects reliability of components, significantly limits useful life of the engines, increases environmental pollution, and increases probability of failure per hour of operation. As a result, the aircraft operators are forced to perform frequent and extensive maintenance of the engines on their fleet, driving the cost of operating traditionally-powered aircraft, and, in turn, drive the cost of air transportation to the end user.

In the commercial aviation market, the high maintenance and fuel costs for the traditional turbine engines drive operating costs for the airlines and other types of operators. Additionally, the continued growth of fossil fuel aviation is increasingly contributing to the particulate pollution around the airports, increased reliance on fossil fuel extraction, as well as the growing climate change impacts. The highspeed exhaust gases of the traditional turbine engines contribute significantly to the extremely large noise footprint of the commercial aviation, especially in the densely populated areas.

Thus, internal combustion engines need replacements, which do not require high maintenance and fuel costs, contribute particulate pollution, rely on fossil fuel, and produce large noise footprint.

### SUMMARY

In order to overcome the foregoing challenges, this disclosure details a hydrogen-electric engine that reduces aircraft noise and heat signatures, improves component reliability, increases the useful life of the engine, limits environmental pollution, and decreases the probability of failure per hour of operation. In particular, this disclosure details a turboshaft engine with an air compressor similar to current turboshaft engines in the front, but with the remaining components being replaced with a fuel cell system that utilizes compressed air and compressed hydrogen to produce electricity that runs motors on an elongated shaft to deliver mechanical power to a propulsor (e.g., a fan or propeller). Generated power is regulated so that no overshoot occurs.

In accordance with an aspect, this disclosure is directed to a hydrogen-electric engine, which includes a fuel cell stack including a plurality of fuel cells, each fuel cell of the plurality of fuel cells including an anode and a cathode, an air compressor system configured to supply compressed air to the cathode, a hydrogen fuel source configured to supply hydrogen gas, an elongated shaft supporting the air compressor system and the fuel cell stack, and a motor assembly disposed in electrical communication with the fuel cell stack. Each fuel cell generates a voltage, as an open cell voltage, by forming water with the supplied compressed air and the supplied hydrogen gas and is electrically coupled with a clamp circuit.

In aspects of this disclosure, the clamp circuit may be configured to clamp an open cell voltage of each fuel cell to a predetermined voltage. The predetermined voltage may be about 0.7 volts. The clamp circuit may be inactive when the open cell voltage of each fuel cell is less than or equal to the predetermined voltage. The clamp circuit may clamp the open cell voltage of each fuel cell when the open cell voltage is greater than the predetermined voltage.

In aspects of this disclosure, the clamp circuit may be coupled to each fuel cell and the motor assembly in parallel.

In aspects of this disclosure, the motor assembly may include at least one inverter disposed in electrical communication with the at least one motor and the fuel cell stack. The inverter may convert direct current from the fuel cell stack into alternating current that actuates the at least one motor.

In aspects of this disclosure, the fuel cell stack may be disposed concentrically about the elongated shaft.

In aspects of this disclosure, the hydrogen-electric engine may further include a controller disposed in electrical communication with at least one of the air compressor system, the hydrogen fuel source, the fuel cell stack, the heat exchanger, or the motor assembly.

In aspects of this disclosure, the hydrogen-electric engine may further comprise a pump in fluid communication with the hydrogen fuel source and the heat exchanger. The pump may be configured to pump liquid hydrogen from the hydrogen fuel source to the heat exchanger.

In aspects of this disclosure, the supplied hydrogen gas may be ionized to provide electrons to the anode and protons through the cathode. The protons may react with oxygen from the supplied compressed air and electrons from the cathode to form water.

In aspects of this disclosure, the anode may include a proton exchange membrane.

In one aspect, this disclosure is directed to a method for regulating a voltage generated from a fuel cell of a hydrogen-electric engine. The method includes supplying compressed air to a cathode of a fuel cell of a hydrogen-electric engine, supplying hydrogen gas to an anode of the fuel cell, generating a DC voltage by chemically forming water with the hydrogen gas and oxygen from the supplied compressed air, inverting the DC voltage to an AC voltage, determining whether the AC voltage is greater than a predetermined voltage, and clamping, by a clamping circuit, the AC voltage to the predetermined voltage when the AC voltage is determined to be greater than the predetermined voltage.

In aspects of this disclosure, the supplied hydrogen may be split to provide electrons to the anode and protons through the cathode. The protons and oxygen from the supplied compressed air may interact to form water. The electrons from the anode may move to the cathode to form the water.

In aspects of this disclosure, when the open cell voltage is determined to be less than or equal to the predetermined voltage, the clamping circuit may not be activated.

In aspects of this disclosure, the predetermined voltage may be about 0.7.

In yet another aspect, this disclosure is directed to a non-transitory computer readable storage medium including processor-executable instructions stored thereon that, when executed by a processor, cause the processor to perform a method for regulating a voltage generated from a fuel cell of a hydrogen-electric engine. The method includes supplying compressed air to a cathode of a fuel cell of a hydrogen-electric engine, supplying hydrogen gas to an anode of the fuel cell, generating a DC voltage by chemically forming water with the hydrogen gas and oxygen from the supplied compressed air, inverting the DC voltage to an AC voltage, determining whether the AC voltage is greater than a predetermined voltage, and clamping, by a clamping circuit, the AC voltage to the predetermined voltage when the AC voltage is determined to be greater than the predetermined voltage.

Other aspects, features, and advantages will be apparent from the description, the drawings, and the claims that follow.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying figures of which:

FIG. 1 is a schematic view of a hydrogen-electric engine system in accordance with aspects of this disclosure;

FIG. 2 is a schematic view of a fuel cell of the hydrogen-electric engine system of FIG. 1;

FIG. 3 is a block diagram of a clamp circuit for a fuel cell in accordance with aspects of this disclosure;

FIG. 4 is a flowchart of a method for regulating power in accordance with aspects of this disclosure; and

FIG. 5 is a block diagram of a controller configured for use with the hydrogen-electric engine system of FIG. 1.

Further details and aspects of exemplary aspects of the disclosure are described in more detail below with reference to the appended figures. Aspects of the disclosure may be combined without departing from the scope of the disclosure.

### DETAILED DESCRIPTION

Although illustrative systems of this disclosure will be described in terms of specific aspects, it will be readily apparent to those skilled in this art that various modifications, rearrangements, and substitutions may be made without departing from the spirit of this disclosure.

For purposes of promoting an understanding of the principles of this disclosure, reference will now be made to exemplary aspects illustrated in the figures, and specific language will be used to describe the same. It will nevertheless be understood that no limitation of the scope of this disclosure is thereby intended. Any alterations and further modifications of this disclosure features illustrated herein, and any additional applications of the principles of this disclosure as illustrated herein, which would occur to one skilled in the relevant art and having possession of this disclosure, are to be considered within the scope of this disclosure.

In the following description, well-known functions or constructions are not described in detail to avoid obscuring the present disclosure in unnecessary detail.

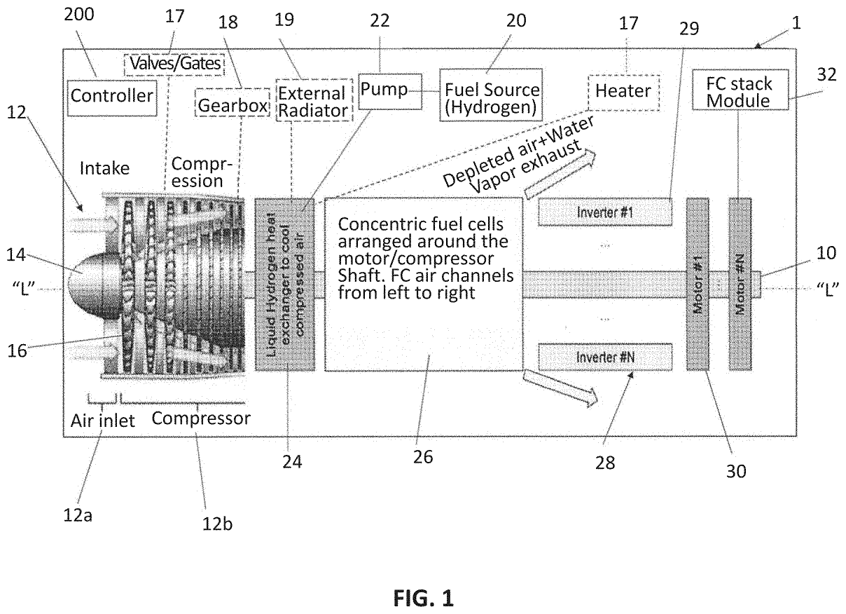

FIG. 1 illustrates an integrated hydrogen-electric engine system 1 that can be utilized, for example, in a turboprop or turbofan system, to provide a streamlined, light weight, power dense and efficient system. In general, integrated hydrogen-electric engine system 1 includes an elongated shaft 10 that defines a longitudinal axis “L” and extends through the entire powertrain of integrated hydrogen-electric engine system 1 to function as a common shaft for the various components of the powertrain. Elongated shaft 10 supports propulsor 14 (e.g., a fan or propeller) and a multi-stage air compressor system 12, a pump 22 in fluid communication with a fuel source (e.g., hydrogen), a heat exchanger 24 in fluid communication with air compressor system 12, a fuel cell stack 26 in fluid communication with heat exchanger 24, and a motor assembly 28 disposed in electrical communication with fuel cell stack 26.

Air compressor system 12 of integrated hydrogen-electric engine system 1 includes an air inlet portion 12a at a distal end thereof and a compressor portion 12b that is disposed proximally of air inlet portion 12a for uninterrupted, axial delivery of air flow in the proximal direction. Compressor portion 12b supports a plurality of longitudinally spaced-apart rotatable compressor wheels 16 (e.g., multi-stage) that rotate in response to rotation of elongated shaft 10 for compressing air received through air inlet portion 12a for pushing the compressed air to a fuel cell stack 26 for conversion to electrical energy. As can be appreciated, the number of compressor wheels/stages 16 and/or diameter, longitudinal spacing, and/or configuration thereof can be modified as desired to change the amount of air supply, and the higher the power, the bigger the propulsor 14. These compressor wheels 16 can be implemented as axial or centrifugal compressor stages. Further, the compressor can have one or more bypass valves and /or wastegates 17 to regulate the pressure and flow of the air that enters the downstream fuel cell, as well as to manage the cold air supply to any auxiliary heat exchangers in the system.

Compressor 12 can optionally be mechanically coupled to elongated shaft 10 via a gearbox 18 to change (increase and/or decrease) compressor turbine rotations per minute (RPM) and to change the air flow to fuel cell stack 26. For instance, gearbox 18 can be configured to enable the air flow, or portions thereof, to be exhausted for controlling a rate of air flow through fuel cell stack 26, and thus, the output power.

Hydrogen-electric engine system 1 further includes a gas management system such as a heat exchanger 24 disposed concentrically about elongated shaft 24 and configured to control thermal and/or humidity characteristics of the compressed air from air compressor system 12 for conditioning the compressed air before entering fuel cell stack 26. Hydrogen-electric engine system 1 also further includes a fuel source 20 of fuel cryogenic (e.g., liquid hydrogen -LH2, or cold hydrogen gas) that is operatively coupled to heat exchanger 24 via a pump 22 configured to pump the fuel from fuel source 20 to heat exchanger 24 for conditioning compressed air. In particular, the fuel, while in heat exchanger 24, becomes gasified because of heating (e.g., liquid hydrogen is converted to gas) to take the heat out of the system. The hydrogen gas then get heated in the heat exchanger 24 to a working temperature of fuel cell stack 26 which also takes heat out of the compressed air, which results in a control of flow through heat exchanger 24. In aspects, heater 17 can be coupled to or included with heat exchanger 24 to increase heat as necessary, for instance, when running under a low power regime. Additionally, and/or alternatively, motor assembly 28 can be coupled to heat exchanger 24 for looping in the cooling/heating loops from motor assembly 28 as necessary. Such heating/cooling control can be managed, for instance, via controller 200 of hydrogen-electric engine system 1. In aspects, fuel source 20 can be disposed in fluid communication with motor assembly 28 or any other suitable component to facilitate cooling of such components.

Pump 22 can also be coaxially supported on elongated shaft 10 for actuation thereof in response to rotation of elongated shaft 10. Heat exchanger 24 is configured to cool the compressed air received from air compressor system 12 with the assistance of the pumped liquid hydrogen.

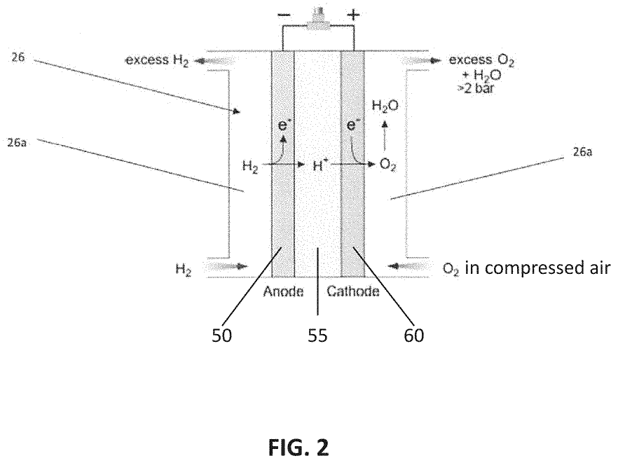

With reference also to FIG. 2, hydrogen-electric engine system 1 further includes an energy core in the form of fuel cell stack 26, which may be circular, and is also coaxially supported on elongated shaft 10 (e.g., concentric). The fuel cells of the fuel cell stack 26 are configured to convert chemical energy liberated during the electrochemical reaction of hydrogen and oxygen to electrical energy (e.g., direct current). Air channels 26a of fuel cell stack 26 may be oriented in parallel relation with elongated shaft 10 (e.g., horizontally or left-to-right). Fuel cell stack 26 may be in the form of a proton-exchange membrane fuel cell (PEMFC). In aspects, each fuel cell in fuel cell stack 26 may include an anode 50 (e.g., a negative terminal), an electrolyte 55, and a cathode 60 (e.g., a positive terminal).

When the hydrogen gas is supplied to anode 50 of each fuel cell, the hydrogen gas is ionized at the membrane of anode 50. The membrane may include catalyst, such as platinum powder or any other suitable catalyst, which facilitates separation of the hydrogen molecule into protons and electrons. Specifically, one hydrogen molecule is catalytically ionized to two electrons and two protons as set forth below:

H₂Δ2H⁺+2e⁻,

where H⁺ is a proton and e⁻ is an electron. Since not every hydrogen molecule is ionized, the non-ionized hydrogen molecules exit air channels 26a to the outside. In an aspect, the exited hydrogen molecules may be stored and recycled later after a purification process.

The electrons move to anode 50 and travel to cathode 60, which forms current and activates electrical components of hydrogen-electric engine system 1. The protons permeate through electrolyte 55 to cathode 60. When the air is supplied to air channel 26a, oxygen in the supplied air is also supplied to cathode 60. Cathode 60 may include a cathode catalyst, such as nickel, for converting ions into waste such as water. Indeed, the protons, which permeate the electrolyte 55 to cathode 60, and the electrons, which travels from anode 50 to cathode 60, chemically react with the oxygen, thereby forming water molecules, as set forth below:

2H⁺+2e⁻+½O₂→H₂O.

As non-ionized hydrogen molecules exit air channel 26a, not-reacted oxygen molecules, water molecules, and the other constituents of the air also exit air channel 26a . Based on the chemical energy difference from this cycle of formation of water molecules from the hydrogen gas and the air, a potential, which is a direct current (DC) voltage, is generated between anode 50 and cathode 60, and this potential is the voltage that each fuel cell can generate.

When the generated voltage is within a workable range of voltages, hydrogen-electric engine system 1 can work properly as designed. However, if the generated voltage is outside the workable range, hydrogen-electric engine system 1 may not work properly or even damage electrical components thereof. In an aspect, the workable range may be below 0.7 volts. In another aspect, the workable range is measured based on an open cell voltage of the fuel cell.

The fuel cell may be able to generate a voltage over 1.1 volts. In this case, electrical components in hydrogen-electric engine system 1 may be damaged due to the high voltage from the fuel cell. Thus, by regulating the voltage generated by the fuel cell, components of hydrogen-electric engine system 1 can be protected and can work properly.

When the generated voltage is over 1.1 volts, hydrogen-electric engine system 1 may place a load as a voltage divider in series so that only a portion of the generated voltage, which is then within the workable range, is supplied to hydrogen-electric engine system 1. In aspects, the load may be a resistor, rheostat, potentiometer, varistor, variable resistor, or any other electric components, which work as a resistor.

Now referring back to FIG. 1, electrical energy generated from fuel cell stack 26 is then transmitted to motor assembly 28, which is also coaxially/concentrically supported on elongated shaft 10. In aspects, hydrogen-electric engine system 1 may include any number of external radiators 19 (FIG. 1) for facilitating air flow and adding, for instance, additional cooling. Notably, fuel cell stack 26 can include liquid cooled and/or air cooled cell types so that cooling loads are transferred into heat exchanger 28 for reducing a total amount of external radiators needed in the system.

Motor assembly 28 of hydrogen-electric engine system 1 includes a plurality of inverters 29 configured to invert the direct current (DC), which is generated by fuel cell stack 26, to alternating current (AC) for actuating one or more of a plurality of motors 30 in electrical communication with inverters 29. The plurality of motors 30 is configured to drive (e.g., rotate) the elongated shaft 10 in response to the electrical energy received from fuel cell stack 26 for operating the components on the elongated shaft 10 as elongated shaft 10 rotates about a longitudinal axis “L” thereof

In aspects, one or more of the inverters 29 may be disposed between motors 30 (e.g., a pair of motors) to form a motor subassembly, although any suitable arrangement of motors 30 and inverters 29 may be provided. Motor assembly 28 can include any number of motor subassemblies supported on elongated shaft 10 for redundancy and/or safety. Motor assembly 28 can include any number of fuel cell stack modules 32 configured to match the power of motors 30 and inverters 29 of the subassemblies. In this regard, for example, during service, fuel cell stack modules 32 can be swapped in/out. Each module 32 can provide any power, such as 400 kw or any other suitable amount of power, such that when stacked together (e.g., 4 or 5 modules), total power can be about 2 Megawatts on elongated shaft 10. In aspects, motors 30 and inverters 29 can be coupled together and positioned to share the same thermal interface so a motor casing of motors 30 is also an inverter heat sink so only a single cooling loop goes through motor assembly 28 for cooling inverters 29 and motors 30 at the same time. This reduces the number of cooling loops and therefore the complexity of the system.

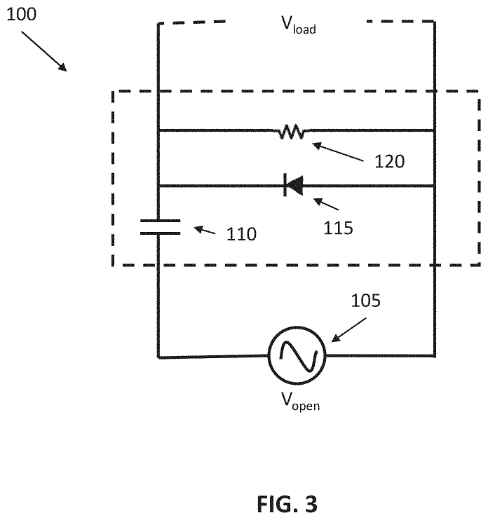

When the generated DC voltage is inverted, the AC voltage may be greater than a workable range of voltages. Based on requirements of hydrogen-electric engine system 1, the amplitude of the AC voltage may have to be changed/adjusted. Further, the DC level of the AC voltage may need be also changed/adjusted. Thus, as illustrated in FIG. 3, hydrogen-electric engine system 1 may include a clamp circuit 100 coupled between inverters 29 and motors 30. As illustrated in FIG. 3, inverter 29 together with fuel cell stack 2 acts as a power source 105. Without connecting to any load, the potential, which power source 105 can provide, is the open cell voltage, Vₒₚₑₙ. When the open cell voltage Vₒₚₑₙ is greater than a predetermined threshold, components of hydrogen-electric engine system 1 can be damaged. Thus, clamp circuit 100 may be electrically coupled to terminals of power source 105.

In aspects, clamp circuit 100 may be a positive damper, which raises the negative peak on the zero level, a negative damper, which lowers the positive peak on the zero level, a positive bias damper, which raises the negative peak to be greater than the zero level, or a negative bias damper, which lowers the positive peak to be less than the zero level. Clamp circuit 100 may be a positive damper with negative bias, which raises the negative peak up to a value lower than the zero level, and a negative damper with positive bias, which lowers the positive peak down to a value greater than the zero value.

Now referring back to FIG. 3, a positive clamping circuit 100, as an example of the clamping circuit, includes a capacitor 110, a diode 115, and a resistor 120. In particular, capacitor 110 is connected in series with power source 105, and diode 115 and resistor 120 are connected in parallel with power source 105. In an aspect, based on the direction where diode 115 blocks current, clamping circuit 100 may work as a positive or negative clamping circuit. Further, when another voltage source is connected with the diode, positive and negative bias is added to the clamped voltage signal. The capacitance of capacitor 110, the blocking direction of diode 115, and the resistance of resistor 120 may be adjusted to meet requirements of hydrogen- electric engine system 1. The components in clamp circuit 100 are not limited to this example but can include other electric components to deliver the desired voltage to motor assembly 28.

In aspects, clamp circuit 100 may be replaced with a voltage divider (e.g., a resistor, a variable resistor, and the like) in series with power source 105. Based on the impedance of the load (e.g., motor assembly 28), the voltage divider can be adjusted to deliver the desired voltage to motor assembly 28.

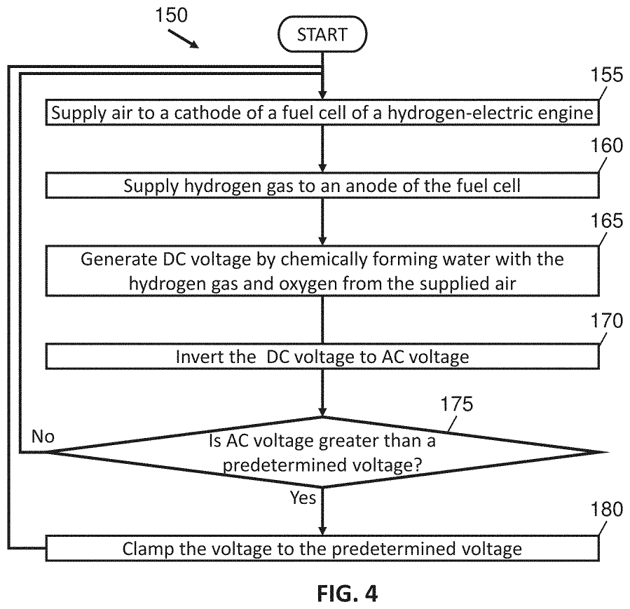

FIG. 4 illustrates a method 150 for regulating a voltage generated by a fuel cell (e.g., a fuel cell in the fuel cell stack 26 of FIG. 1) of a hydrogen-electric system (e.g., the hydrogen-electric system 1 of FIG. 1) according to aspects of this disclosure. Method 150 controls the level of voltage, which is generated by the fuel cell, to be within a workable range so that hydrogen-electric system can operate as designed.

In step 155, compressed air are supplied to provide oxygen molecules O₂ to a cathode (e.g., the cathode 60 of FIG. 2) of the fuel cell, and in step 160, hydrogen gas H₂ is supplied to an anode (e.g., the anode 50 of FIG. 2) of the fuel cell. In aspects, steps 155 and 160 may be interchangeable in order or simultaneously performed. The anode may include a membrane, which facilitates separation of the hydrogen molecules into electrons and protons, and the cathode may include another membrane, which facilitates chemical reactions among protons, oxygen molecules, and electrons to form water molecules H₂O.

Based on the separation of the hydrogen molecules and formation of the water molecules, a DC voltage potential is generated between the anode and the cathode in step 165. Here, the chemical reactions are translated into an electrical potential difference or the DC voltage. In step 170, the DC voltage is inverted to AC voltage so that the motor and other component of the hydrogen-electric system can be powered and run.

In step 175, it is determined whether or not the AC voltage is greater than a predetermined voltage. When it is determined that the AC voltage is greater than the predetermined voltage, the AC voltage is clamped in step 180 so that the clamped voltage is less than or equal to the predetermined voltage.

When the AC voltage is determined not to be greater than the predetermined voltage, steps 155-180 are repeated. In this way, the hydrogen-electric system can maintain the voltage in the workable range.

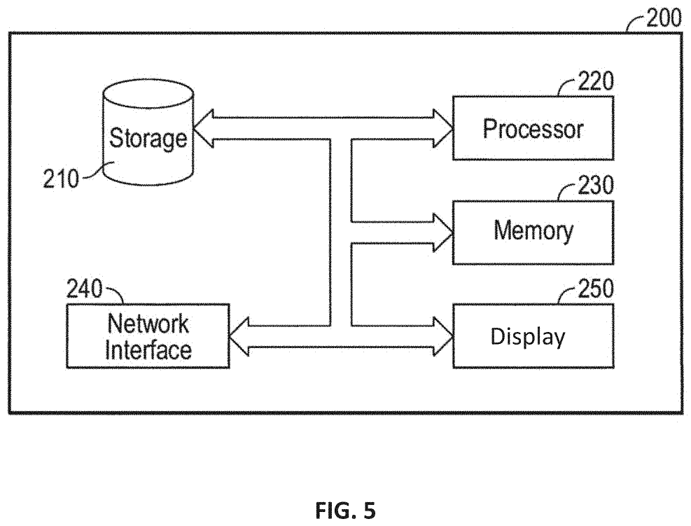

FIG. 5 illustrates that hydrogen-electric engine system 1 further includes a controller 200 (e.g., a full authority digital engine (or electronics) control (e.g., a FADEC)) for controlling the various aspects of hydrogen-electric engine system 1 and/or other components of aircraft system. For instance, controller 200 can be configured to manage a flow of liquid hydrogen, manage coolant liquids from the motor assembly 28, manage, for example, any dependent auxiliary heater for the liquid hydrogen, manage rates of hydrogen going into fuel cell stack 26, manage rates of heated/cooled compressed air, and/or various flows and/or power of hydrogen-electric engine system 1. The algorithm for managing these thermal management components can be designed to ensure the most efficient use of the various cooling and heating capacities of the respective gases and liquids (e.g., fluids) to maximize the efficiency of the system and minimize the volume and weight of same. For example, the cooling capacity of liquid hydrogen or cool hydrogen gas (post-gasification) can be effectively used to cool the hot compressor discharge air to ensure the correct temperature range in the fuel cell inlet. Further, the cooling liquid from the motor-inverter cooling loop could be transferred into the master heat exchanger and arranged to provide the additional heat required to gasify hydrogen and heat the hydrogen to the working fuel cell temperature.

The controller 200 is configured to receive among other data, the fuel supply status, aircraft location, and control, among other features, the pumps, motors, sensors, etc.

Further, as can be appreciated, hydrogen-electric engine system 1 includes any number and/or type of sensors, electrical components, and/or telemetry devices that are operatively coupled to controller 200 for facilitating the control, operation, and/or input/out of the various components of hydrogen-electric engine system 1 for improving efficiencies and/or determining errors and/or failures of the various components.

Controller 200 includes a processor 220 connected to a computer-readable storage medium 210 or a memory 230. The computer-readable storage medium 210 or memory 230 may be one or more physical apparatus used to store data or programs on a temporary or permanent basis. Further, memory 230 stores suitable instructions, to be executed by processor 220, for receiving data from sensors of various components of hydrogen-electric engine system 1, accessing storage 210 of controller 200, processing the data, determining whether values of settings need an update, performing controls/methods (e.g., method 150 of FIG. 4) for hydrogen-electric engine system 1, and displaying data to a graphic user interface.

In aspects of the disclosure, computer-readable storage medium 210 or memory 230 can be random access memory, read-only memory, magnetic disk memory, solid-state memory, optical disc memory, and/or another type of memory. In some aspects of the disclosure, memory 230 can be separate from the controller 200 and can communicate with processor 220 through communication buses of a circuit board and/or through communication cables such as serial ATA cables or other types of cables.

In various aspects, controller 200 includes non-volatile memory, which retains stored information when it is not powered. In some aspects, the non-volatile memory includes flash memory. In certain aspects, the non-volatile memory includes dynamic random-access memory (DRAM). In some aspects, the non-volatile memory includes ferroelectric random-access memory (FRAM). In various aspects, the non-volatile memory includes phase-change random access memory (PRAM). In certain aspects, the controller is a storage device including, by way of non-limiting examples, CD-ROMs, DVDs, flash memory devices, magnetic disk drives, magnetic tapes drives, optical disk drives, and cloud-computing-based storage. In various aspects, the storage and/or memory device is a combination of devices such as those disclosed herein.

In various aspects of the disclosure, controller 200 may include any type of computing device, computational circuit, or any type of processor or processing circuit capable of executing a series of instructions that are stored in memory. Processor 220 may be another type of processor such as, without limitation, a digital signal processor, a microprocessor, an ASIC, a graphics processing unit (GPU), a field-programmable gate array (FPGA), or a central processing unit (CPU). Controller 200 may include multiple processors and/or multicore central processing units (CPUs) and may include any type of processor, such as a microprocessor, digital signal processor, microcontroller, programmable logic device (PLD), field programmable gate array (FPGA), or the like.

In aspects of the disclosure, controller 200 may include a network interface 240 to communicate with other computers or to a server. In certain aspects of the disclosure, network inference 240 may also be accomplished in systems that have weights implemented as memristors, chemically, or other inference calculations, as opposed to processors.

As used herein, network interface 240 may include any network technology including, for instance, a cellular data network, a wired network, a fiber-optic network, a satellite network, and/or an IEEE 802.11a/b/g/n/ac wireless network, among others.

In various aspects, hydrogen-electric engine system 1, while navigating, may be coupled to a mesh network, which is a network topology in which each node relays data for the network, via network interface 240. All mesh nodes cooperate in the distribution of data in the network. It can be applied to both wired and wireless networks. Wireless mesh networks can be considered a type of “Wireless ad hoc” network. Thus, wireless mesh networks are closely related to Mobile ad hoc networks (MANETs). Although MANETs are not restricted to a specific mesh network topology, Wireless ad hoc networks or MANETs can take any form of network topology. Mesh networks can relay messages using either a flooding technique or a routing technique. With routing, the message is propagated along a path by hopping from node to node until it reaches its destination. To ensure that all its paths are available, the network must allow for continuous connections and must reconfigure itself around broken paths, using self-healing algorithms such as Shortest Path Bridging.

Self-healing allows a routing-based network to operate when a node breaks down or when a connection becomes unreliable. As a result, the network is typically quite reliable, as there is often more than one path between a source and a destination in the network. This concept can also apply to wired networks and to software interaction.

In some aspects, controller 200 may include a display 250 to send visual information to a user. In various aspects, the display is a cathode ray tube (CRT). In various aspects, the display is a liquid crystal display (LCD). In certain aspects, the display is a thin film transistor liquid crystal display (TFT-LCD). In aspects, the display is an organic light emitting diode (OLED) display. In certain aspects, on OLED display is a passive-matrix OLED (PMOLED) or active-matrix OLED (AMOLED) display. In aspects, the display is a plasma display. In certain aspects, the display is a video projector. In various aspects, the display is interactive (e.g., having a touch screen or a sensor such as a camera, a 3D sensor, a LiDAR, a radar, etc.) that can detect user interactions/gestures/responses and the like. In some aspects, the display is a combination of devices such as those disclosed herein.

In some aspects, controller 200 may include one or more modules. As used herein, the term “module” and like terms are used to indicate a self-contained hardware component of the central server, which in turn includes software modules. In software, a module is a part of a program. Programs are composed of one or more independently developed modules that are not combined until the program is linked. A single module can contain one or several routines, or sections of programs that perform a particular task.

As used herein, controller 200 includes software modules for managing various aspects and functions of the disclosed system or components thereof.

As can be appreciated, securement of any of the components of the disclosed systems can be effectuated using known securement techniques such welding, crimping, gluing, fastening, etc.

It should be understood that the disclosed structure can include any suitable mechanical, electrical, and/or chemical components for operating the disclosed system or components thereof. For instance, such electrical components can include, for example, any suitable electrical and/or electromechanical, and/or electrochemical circuitry, which may include or be coupled to one or more printed circuit boards.

In some aspects, controller 200 includes an operating system configured to perform executable instructions. The operating system is, for example, software, including programs and data, which manages hardware of the disclosed apparatus and provides services for execution of applications for use with the disclosed apparatus. Those of skill in the art will recognize that suitable server operating systems include, by way of non-limiting examples, FreeBSD, OpenBSD, NetB SD®, Linux, Apple® Mac OS X Server®, Oracle® Solaris®, Windows Server®, and Novell® NetWare®. In some aspects, the operating system is provided by cloud computing.

The term “application” may include a computer program designed to perform particular functions, tasks, or activities for the benefit of a user. Application may refer to, for example, software running locally or remotely, as a standalone program or in a web browser, or other software which would be understood by one skilled in the art to be an application. An application may run on the disclosed controllers or on a user device, including for example, on a mobile device, an IOT device, or a server system.

Any of the herein described methods, programs, algorithms or codes may be converted to, or expressed in, a programming language or computer program. The terms “programming language” and “computer program,” as used herein, each include any language used to specify instructions to a computer, and include (but is not limited to) the following languages and their derivatives: Assembler, Basic, Batch files, BCPL, C, C+, C++, Delphi, Fortran, Java, JavaScript, machine code, operating system command languages, Pascal, Perl, PL1, scripting languages, Verilog, Visual Basic, metalanguages which themselves specify programs, and all first, second, third, fourth, fifth, or further generation computer languages. Also included are database and other data schemas, and any other meta-languages. No distinction is made between languages which are interpreted, compiled, or use both compiled and interpreted approaches. No distinction is made between compiled and source versions of a program. Thus, reference to a program, where the programming language could exist in more than one state (such as source, compiled, object, or linked) is a reference to any and all such states. Reference to a program may encompass the actual instructions and/or the intent of those instructions.

The phrases “in an aspect,” “in aspects,” “in various aspects,” “in some aspects,” or “in other aspects” may each refer to one or more of the same or different aspects in accordance with the present disclosure. Similarly, the phrases “in an embodiment,” “in embodiments,” “in various embodiments,” “in some embodiments,” or “in other embodiments” may each refer to one or more of the same or different embodiments in accordance with the present disclosure. A phrase in the form “A or B” means “(A), (B), or (A and B).” A phrase in the form “at least one of A, B, or C” means “(A); (B); (C); (A and B); (A and C); (B and C); or (A, B, and C).”

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques).

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

Persons skilled in the art will understand that the structures and methods specifically described herein and illustrated in the accompanying figures are non-limiting exemplary aspects, and that the description, disclosure, and figures should be construed merely as exemplary of particular aspects. It is to be understood, therefore, that this disclosure is not limited to the precise aspects described, and that various other changes and modifications may be effectuated by one skilled in the art without departing from the scope or spirit of the disclosure. Additionally, it is envisioned that the elements and features illustrated or described in connection with one exemplary aspect may be combined with the elements and features of another without departing from the scope of this disclosure, and that such modifications and variations are also intended to be included within the scope of this disclosure. Indeed, any combination of any of the disclosed elements and features is within the scope of this disclosure. Accordingly, the subject matter of this disclosure is not to be limited by what has been particularly shown and described.

What is claimed is:

1. A hydrogen-electric engine comprising:
a fuel cell stack including a plurality of fuel cells, each fuel cell of the plurality of fuel cells including an anode and a cathode;
an air compressor system configured to supply compressed air to the cathode;
a hydrogen fuel source configured to supply hydrogen gas;
an elongated shaft supporting the air compressor system and the fuel cell stack; and
a motor assembly disposed in electrical communication with the fuel cell stack,
wherein each fuel cell generates a voltage, as an open cell voltage, by forming water with the supplied compressed air and the supplied hydrogen gas, and
wherein each fuel cell is electrically coupled with a clamp circuit.

2. The hydrogen-electric engine of claim 1, wherein the clamp circuit is configured to clamp an open cell voltage of each fuel cell to a predetermined voltage.

3. The hydrogen-electric engine of claim 2, wherein the predetermined voltage is about 0.7 volts.

4. The hydrogen-electric engine of claim 2, wherein the clamp circuit is inactive when the open cell voltage of each fuel cell is less than or equal to the predetermined voltage.

5. The hydrogen-electric engine of claim 2, wherein the clamp circuit clamps the open cell voltage of each fuel cell when the open cell voltage is greater than the predetermined voltage.

6. The hydrogen-electric engine of claim 1, wherein the clamp circuit is coupled to each fuel cell and the motor assembly in parallel.

7. The hydrogen-electric engine of claim 1, wherein the motor assembly includes at least one inverter disposed in electrical communication with the at least one motor and the fuel cell stack.

8. The hydrogen-electric engine of claim 7, wherein the inverter converts direct current from the fuel cell stack into alternating current that actuates the at least one motor.

9. The hydrogen-electric engine of claim 1, wherein the fuel cell stack is disposed concentrically about the elongated shaft.

10. The hydrogen-electric engine of claim 1, further comprising a controller disposed in electrical communication with at least one of the air compressor system, the hydrogen fuel source, the fuel cell stack, the heat exchanger, or the motor assembly.

11. The hydrogen-electric engine of claim 1, wherein the supplied hydrogen gas is ionized to provide electrons to the anode and protons through the cathode.

12. The hydrogen-electric engine of claim 11, wherein the protons reacts with oxygen from the supplied compressed air and electrons from the cathode to form water.

13. The hydrogen-electric engine of claim 1, wherein the anode includes a proton exchange membrane.

14. A method for regulating a voltage generated from a fuel cell of a hydrogen-electric engine, the method comprising:
supplying compressed air to a cathode of a fuel cell of a hydrogen-electric engine;
supplying hydrogen gas to an anode of the fuel cell;
generating a DC voltage by chemically forming water with the hydrogen gas and oxygen from the supplied compressed air;
inverting the DC voltage to an AC voltage;
determining whether the AC voltage is greater than a predetermined voltage; and
clamping, by a clamping circuit, the AC voltage to the predetermined voltage when the AC voltage is determined to be greater than the predetermined voltage.

15. The method of claim 14, wherein the supplied hydrogen is split to provide electrons to the anode and protons through the cathode.

16. The method of claim 15, wherein the protons and oxygen from the supplied compressed air interact to form water.

17. The method of claim 16, wherein the electrons from the anode move to the cathode to form the water.

18. The method of claim 14, wherein, when the open cell voltage is determined to be less than or equal to the predetermined voltage, the clamping circuit is not activated.

19. The method of claim 10, wherein the predetermined voltage is about 0.7.

20. A non-transitory computer readable storage medium including processor-executable instructions stored thereon that, when executed by a processor, cause the processor to perform a method for regulating a voltage generated from a fuel cell of a hydrogen-electric engine, the method comprising:
supplying compressed air to a cathode of a fuel cell of a hydrogen-electric engine;
supplying hydrogen gas to an anode of the fuel cell;
generating a DC voltage by chemically forming water with the hydrogen gas and oxygen from the supplied compressed air;
inverting the DC voltage to an AC voltage;
determining whether the AC voltage is greater than a predetermined voltage; and
clamping, by a clamping circuit, the AC voltage to the predetermined voltage when the AC voltage is determined to be greater than the predetermined voltage.
